(19) United States
(12) Patent Application Publication
(10) Pub. No.: US 2013/0255591 A1
(43) Pub. Date: Oct. 3, 2013

(54) Multiple Sequential Shot Dog Training Apparatus

(71) Applicant: WILSON RETRIEVERS, INC., Wampum, PA (US)

(72) Inventors: John Michael Shearer, Lower Burrell, PA (US); Douglas A. Wilson, Wampum, PA (US)

(73) Assignee: Wilson Retrievers, Inc., Wampum, PA (US)

(21) Appl. No.: 13/855,458

(22) Filed: Apr. 2, 2013

Related U.S. Application Data
(60) Provisional application No. 61/619,731, filed on Apr. 3, 2012.

(51) Int. Cl. A01K 15/02; F41B 7/00

(52) U.S. Cl. CPC A01K 15/02; F41B 7/00
USPC 119/707; 124/17

(57) ABSTRACT

A portable device for launching a plurality of retriever dummies is described. The device is light-weight, portable, can be remotely triggered, and requires only a single person to operate. The device has a plurality of legs secured to a main beam and at least one strut extending from the main beam. The legs are preferably articulated and can function as struts. Elastomeric bands extend from a basket to the strut, through a pulley, and back to an anchor. The bands are stretched so that the basket can be fastened to a release mechanism. A retriever object can be placed in the basket. An operator can distance himself from the device and, using a remote control, disengage the fastener from the release mechanism so that the object is launched. The release mechanism is capable of retaining an elastomeric band under high tension while permitting its release using a low voltage electric motor.

The present invention claims priority to and incorporates by reference U.S. provisional application No. 61/412,683.

### FIELD OF THE INVENTION

The present invention relates to a launching device for training a dog to retrieve.

### BACKGROUND OF THE INVENTION

The training of retriever dogs typically includes throwing an object or objects that can be of various weights and sizes, such as a retrieving dummy and bird imitations, so that the dog can retrieve the object. Objects can be thrown by hand, but this is labor intensive and usually requires a trainer and several assistants. Alternatively, objects can be launched into the air by single shot, manually loaded catapults. Propellants can include elastomeric bands, blank cartridges or compressed air. Single shot catapults generally require two or more people to operate efficiently because such catapults must he manually loaded after each shot. This restricts the ability of a single, lone trainer to train or practice dogs for field trials and hunt tests.

Some launchers can throw multiple objects using multiple stations. This allows the trainer to train a dog using less energy. Assistants may still be needed to launch the objects. Also, multiple launch devices are often heavy, cumbersome, awkward to place in training locations, and difficult to set up.

If a trainer desires to eliminate the need for an assistant, a multiple launch device must duplicate all activities performed by assistants and preferably at lower cost. The device should a) be able to launch remotely and accurately various sizes and weights of objects; b) be light, portable, and collapsible; c) permit setup by a single individual; d) provide adjustable launch height, angle, and distance; e) provide a simulated gunshot sound on launch; and f) provide for the use of a remote controlled release mechanism.

Prior art devices are either ineffective in replacing all of the characteristics noted above or are so difficult and time consuming to transport and set up that they do not provide any savings in time or expense.

### SUMMARY OF THE INVENTION

The present invention describes a portable, multiple, sequential shot dog training device. The device permits a single operator to set-up the device and to load it with multiple training dummies. The device also allows remote and separate launching of each object. The angle and direction of launch can be easily adjusted.

The device of the present invention includes a plurality of legs secured to a main beam. At least one strut extends from the main beam. In embodiments, an upper portion of a leg can define a strut. Each strut can include a pulley. An elastomeric band extends through the pulley. A first end of the elastomeric band is secured to a basket into which the object will be placed, and a second end is secured to an anchor. In embodiments, the anchor can be on the main beam. Alternatively, the anchor can be on the basket. The basket includes a fastener that permits attachment to a release mechanism on the main beam. In use, an object would be placed in the basket and the elastomeric band is stretched so that the basket fastener engages the release mechanism. This can be repeated for the number of baskets present on the device. An operator can distance himself from the device and, using, a remote control, disengage the fastener from the release mechanism so that the object is launched.

The present invention provides a release mechanism that is capable of retaining an elastomeric band under high tension while permitting its release using only a low voltage electric motor. The release mechanism comprises a servomotor mounted to a base plate. A firing arm including a body and an elongation is pivotally secured to the base plate at a center of rotation in the body. When the firing arm is pivoted substantially parallel to the base plate, the firing arm can retain the stretched elastomeric band. The force of the stretched elastomeric band does not rotate the firing arm because the force is directed through the firing arm's center of rotation release arm is pivotally mourned on the base plate and between the base plate and the elongation of the firing arm. The release arm is connected to the servomotor by an actuator so that a remote signal from the operator will rotate the release arm. Rotation of the release arm can exert an upward force on the firing arm's elongation thereby rotating the firing arm. Rotating the firing arm by increasing the angle between the base plate and the firing arm will release the elastomeric band and launch the object.

In an embodiment of the invention, the firing arm can include a firing pin that strikes a primer holder on the base plate when the elastomeric band is released. Placing a blank cartridge in the primer holder will cause a loud bang, which simulates the sound of a gunshot, to accompany the release of the object.

In another embodiment of the invention, the device includes a reinforcing cable from the main beam to a distant end of the strut. The cable resists flexing caused by extension of the elastomeric band and permits the use of lighter weight material.

In still another embodiment, the legs of the device can be articulated or telescoping. A leg can include a bracket that permits the leg to be folded or bent. This facilitates storage or transportation while facilitating setting the device to various launch angles. The main beam can also be articulated or telescoping provided the beam can be rigidized in use.

### BRIEF DESCRIPTION OF THE DRAWINGS

FIG. 1 shows an embodiment of a device of the present invention.

FIG. 2 shows reinforcing cabling on a top side of the above embodiment.

FIG. 3 shows the above embodiment with the baskets in a loaded position.

FIG. 4 shows an alternative launch position for the above embodiment.

FIG. 5 shows the launch release mechanism and elastomeric cord anchor positions on the main beam.

FIG. 6 shows the release mechanism.

FIG. 7 shows a bracket of the leg including a brace.

### DESCRIPTION OF THE PREFERRED EMBODIMENTS

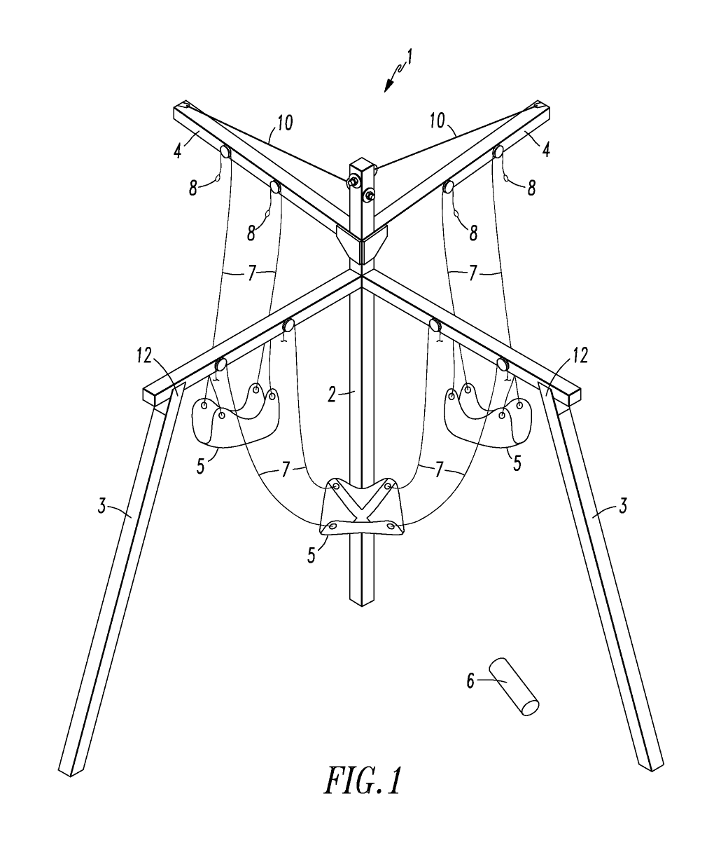

FIG. 1 shows a device 1 of the invention comprising main beam 2 from which extend a plurality of legs 3 and struts 4. The device 1 should have at least two legs 3 so that, in combination with the main beam, the device produces a stable launch platform, such as a tripod, which is able to distribute loads in the cardinal directions Of course, more legs are permitted but add to the weight of the device.

The device 1 can be produced from any convenient material. Lighter weight materials such as aluminum magnesium or carbon fiber facilitate portability. The main beam, legs and struts should be stiff when in use and can have any suitable profile that produces rigidity including, for example, I-beam, C-beam, L channel, or X-beam. The legs 3 of the device 1 can be adjusted, for example, being, articulated or telescoping. For example, the legs 3 can include a bracket 12 that permits the legs 3 to bend at various angles and to fold for easy storage and transport. Bendable legs can permit launching at various angles.

FIG. 7 shows a bracket 12 of the leg 3. The bracket 12 connects the leg 3 to the main beam (not shown), and includes at least one brace 75. In embodiments, the bracket 12 connects to a strut 4, which then connects to the main beam. Alternatively, the bracket 12 can be used to connect a plurality of leg portions to produce an articulated leg. The brace 75 reduces the likelihood that the leg 3 may overextend Overextension can occur either at the leg's intersection with the main beam or with a second portion of an articulated leg. The bracket 12 can elude one or more brace 75 that restrict the rotation of the leg 3.

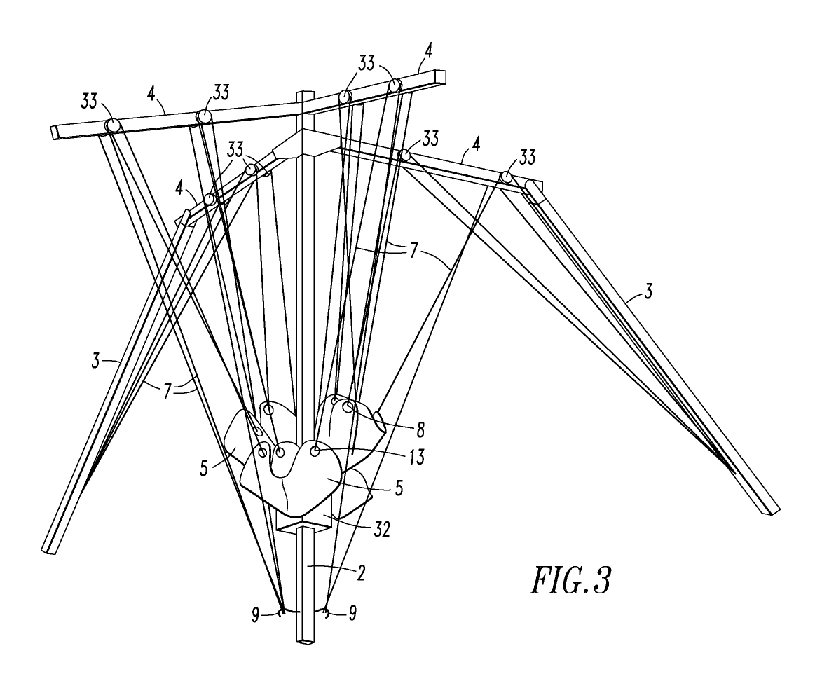

In the embodiment of FIG. 3, an upper portion of each leg 3 also defines a strut 4. Using the legs as struts reduces the weight of the device. The four struts 4 permit at least four baskets 5 for launching multiple dummies. An object 6 can be placed in a basket 5. The basket 5 can be any article capable of bolding an object including, for example, a woven basket, bucket, a cup, or other suitable material. In the shown embodiment, the basket 5 includes a piece of material having grommets on each of its four corners. A plurality of elastomeric bands 7 have a first end 13 attached to the basket 5 and a second end 8 that can be anchored to the basket 5 or the main beam 2.

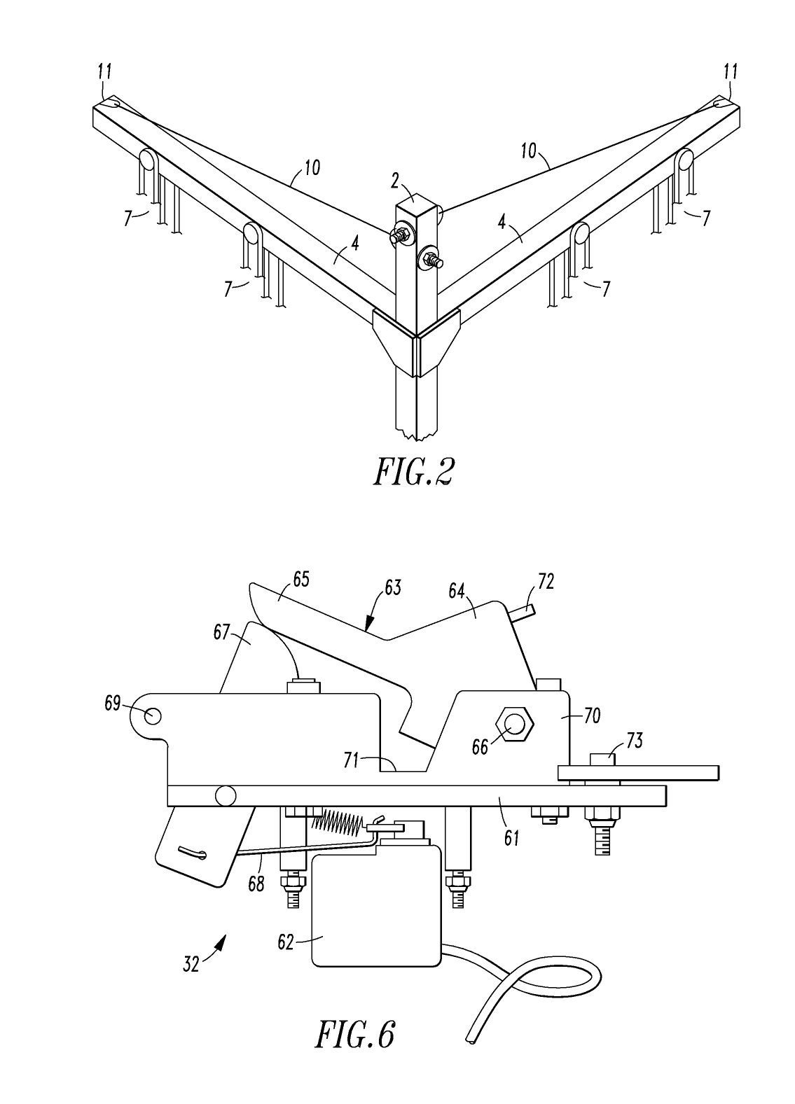

As shown in FIG. 2, cables 10 can be attached from the main beam 2 to the distant end 11 of the struts 4. The cables 10 increase the permissible load on the struts 4 and, therefore, the stored elastic energy in the elastomeric bands 7. Greater elastic energy allows the object (not shown) to travel greater distances. Cables 10 also allow lighter gauge materials to be used without compromising mechanical strength.

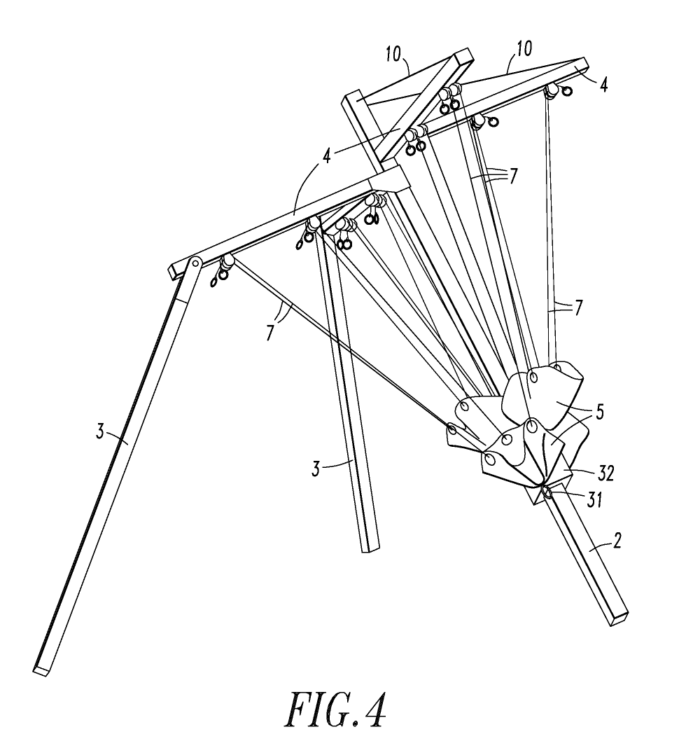

FIGS. 3 and 4 show the device 1 with the baskets 5 in launch position. A fastener 31 secures the basket to a release mechanism 32. In FIG. 3, the first end of the elastomeric band 7 is secured to the basket 5, the elastomeric band is stretched over the pulley 33 on the strut 4, and the second end of the elastomeric band is attached to the anchor 9, which is fixed to the main beam 2. For clarity, the fasteners are omitted from the figure, but they would secure to the release mechanism 32. In the embodiment of FIG. 4, the first end of elastomeric band 7 stretches from the basket 5 over the pulley 33 on the strut 4, and attaches the second end to the basket 5 at a grommet, which is the anchor 9. This embodiment uses fewer elastomeric bands when compared to the embodiment of FIG. 3.

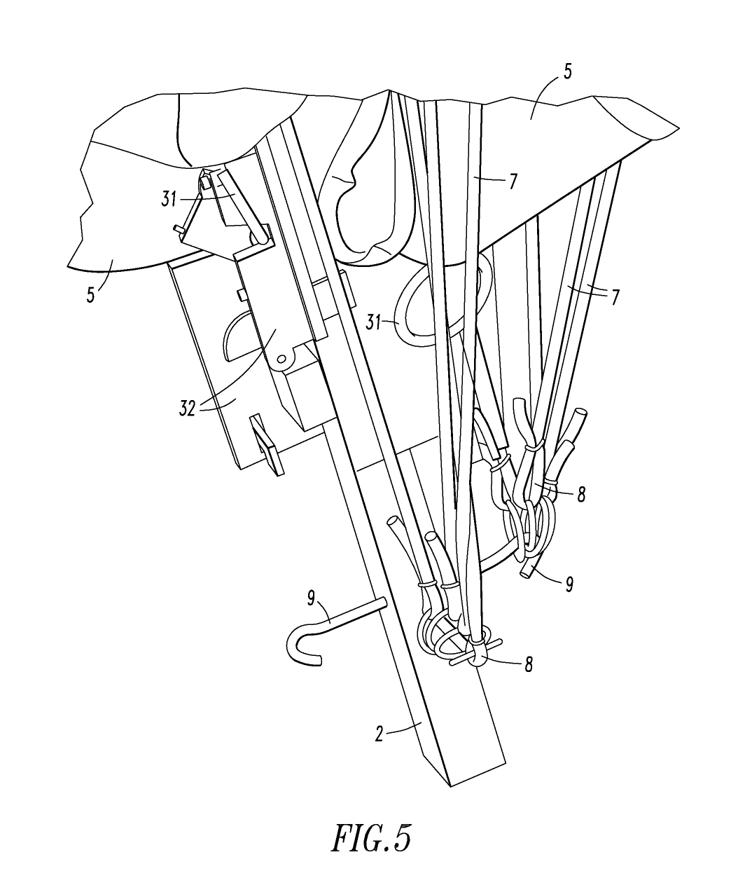

FIG. 5 shows a close-up of the release mechanism 32, fastener 31 and anchor 9. Conveniently, the main beam will include a plurality of anchors. The elastomeric band 7 can be stretched so that the basket 5 is pulled sufficiently close to the release mechanism 32 and the fastener 31 can be locked into the release mechanism 32. In this embodiment, the second end 8 of the elastomeric band 7 is attached to the anchor 9 on the main beam 2. Advantageously, this configuration, when compared with the embodiment of FIG. 4 that anchored the band to the basket, doubles the number of elastomeric bands 7 and can produce double the force on the object.

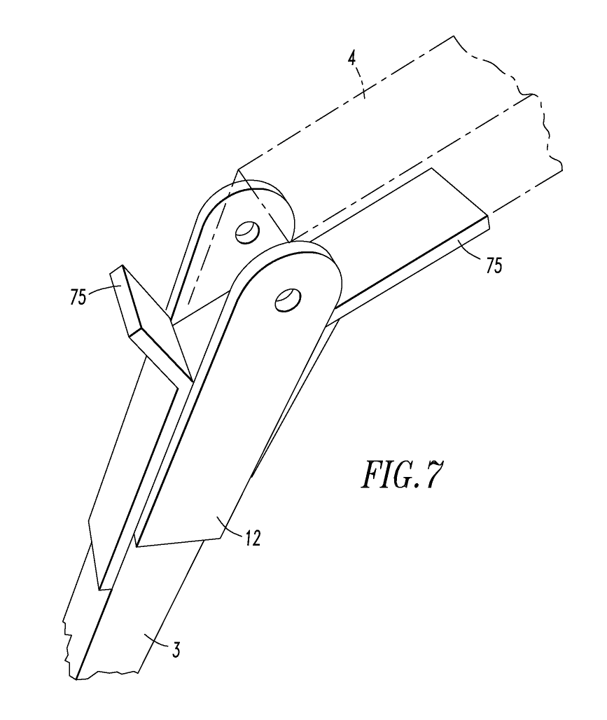

FIG. 6 shows details of the release mechanism 32. Advantageously, the release mechanism of the present invention permits the use of a low voltage servomotor despite the substantial tensile forces exerted by the elastomeric bands. The release mechanism comprises a base plate 61 including a flange 70. The flange 70 defines a notch 71. The notch 71 is able to receive the fastener of the basket. A firing arm 63 includes a body 64 and an elongation 65, and is pivotally secured to the flange 70 at a center of rotation 66. The firing arm 63 is capable of closing over the notch 71 when the fastener is placed in the notch. When the firing arm 63 is pivoted substantially parallel to the base plate 61, the firing arm 63 can retain the stretched elastomeric band because the force of the stretched elastomeric band does not exert a torque on the firing arm 63. The force is directed through the firing arm's center of rotation 66.

A release arm 67 is pivotally mounted on the flange 70 on the other side of the notch 70 from the center of rotation 66. When the tiring arm 63 has locked a fastener in the notch 71, the release arm 67 rests between the base plate 61 and the elongation 65 of the firing arm 63. Rotation of the release arm 67 pushes on the elongation 65 and rotates the firing arm 63 sufficiently so that the stretched elastomeric band can exert a torque on the firing arm 63. This releases the elastomeric band from the notch 71 and launches the object.

The release arm 67 can be remotely moved using, a small electric motor. In FIG. 6, the release arm 67 is connected to a servomotor 62 by an actuator 68. The servomotor can be, for example, a 6 V electric motor. The actuator 68 connects the servomotor 62 to an end of the release arm 67. A remote signal can trigger the servomotor 62 to move the actuator 68 and rotate the release arm 67 away from the base plate 61. Rotation of the release arm 67 exerts an upward force on the elongation 65 thereby rotating the firing arm 63. Rotating the firing, arm 63 by increasing the angle between the base plate 61 and the firing arm 63 will release the elastomeric band and launch the object.

In an embodiment of the invention, the firing arm 63 can include a firing, pin 72 that strikes a primer holder 73 on the base plate 61 when the elastomeric band is released. Placing a blank cartridge in the primer holder 61 will cause a loud bang to accompany the release of the object. The sound can simulate that of a gunshot.

The release mechanism can also include a safety that prevents inadvertent launching of an object. Conveniently, the flange 70 can define a hole 69. A pin (not shown) can extend through the hole and a mating hole (not shown) on the release arm 67. The pin prevents rotation of the release arm 67 and therefore prevents the release arm 67 from rotating the tiring arm 63.

While specific embodiments have been described in detail, it will be appreciated by those skilled in the art that various modifications and alternatives to those details could be developed in light of the overall teachings of the disclosure. Accordingly, the particular embodiments disclosed are mean to be illustrative only and not limiting as to the scope of the method described herein, which is to be given the full breadth of the appended claims and any and all equivalents thereof.

What is claimed is:

1. A portable device for launching a plurality of retriever dummies comprising:
a. a main beam;
b. a plurality of legs secured to the main beam;
c. at least one strut extending from the main beam and including a pulley;
d. a basket for receiving an object;
e. an elastomeric band extending from the basket, through the pulley and to an anchor;
f. a fastener secured to the basket;
g. a release mechanism mounted on the main beam for receiving the fastener when the elastomeric band is stretched.

2. The portable device of claim 1, wherein the release mechanism comprises:
a. a base plate including a flange, the flange defining a notch for receiving the fastener;
b. a firing area including a body and an elongation, and pivotally secured to the flange at a center of rotation, the firing arm capable of closing, over the notch when the fastener is placed in the notch in line with the center of rotation whereby the fastener places no torque on the firing arm;
c. a release arm pivotally mounted on the flange between the base plate and the elongation of the firing arm, whereby rotation of the release arm pushes on the elongation and rotates the firing arm sufficiently so that the fastener exerts a torque on the tiring arm thereby releasing the fastener.

3. The portable device of claim 1, wherein the portable device includes a plurality of struts.

4. The portable device of claim 1, wherein at least one leg includes an upper portion comprising the strut.

5. The portable device of claim 1, wherein at least one leg comprises a profile selected from a group consisting of, I-beam, C-beam, L channel, or X-beam.

6. The portable device of claim 1, wherein at least one leg permits an adjustment.

7. The portable device of claim 6, wherein the adjustment is selected from a group consisting of an articulation or telescoping.

8. The portable device of claim 7, wherein the articulation includes a bracket that permits the leg to bend.

9. The portable device of claim 8, wherein the bracket includes at least one brace that prevents rotation of the leg beyond the brace.

10. The portable device of claim 1, wherein the basket is selected from a group consisting of a woven basket, a bucket, and a cup.

11. The portable device of claim 1, wherein the strut includes a distal end, and a cable extends from the main beam to the distal end of the strut.

12. The portable device of claim 1, wherein the main beam includes the anchor.

13. The portable device of claim 1, wherein the basket includes the anchor.

14. The portable device of claim 2, wherein the release mechanism comprises a servomotor connected to an actuator, and movement of the actuator rotates the release arm, thereby launching the object.

15. The portable device of claim 14, wherein the servomotor can be triggered by a remote control.

16. The portable device of claim 1, wherein release mechanism includes a primer holder, the firing arm includes a firing pin, and rotating the firing arm causes the firing pin to strike the primer holder.

17. The portable device of claim 1, wherein the release mechanism includes a safety that prevents inadvertent launching of an object, the safety comprising the flange defining a hole capable of receiving a pin, whereby the release arm is prevented from rotating.

18. A portable device for launching a plurality of retriever dummies comprising:
a. a main beam comprising an anchor;
b. a plurality of legs secured to the main beam;
c. at least one strut extending from the main beam and including a pulley;
d. a basket for receiving an object;
e. an elastomeric band extending from the basket, through the pulley and to the anchor on the main beam;
f. a fastener secured to the basket;
g. a release mechanism mounted on the main beam for receiving the fastener when the elastomeric band is stretched, the release mechanism comprising (i) a base plate including a flange, the flange defining a notch for receiving the fastener; (ii) a firing arm including a body and an elongation, and pivotally secured to the flange at a center of rotation, the firing arm capable of closing over the notch when the fastener is placed in the notch in line with the center of rotation whereby the fastener places no torque on the firing arm; (iii) a release arm pivotally mounted on the flange between the base plate and the elongation of the firing arm, whereby rotation of the release arm pushes on the elongation and rotates the firing arm sufficiently so that the fastener exerts a torque on the firing arm thereby releasing the fastener.

19. The portable device of claim 18, wherein at least one leg includes an upper portion comprising the strut.

20. A portable device for launching a plurality of retriever dummies comprising:
a. a main beam;
b. a plurality of legs secured to the main beam;
c. at least one strut extending from the main beam and including a pulley;
d. a basket for receiving an object; the basket having an anchor;
e. an elastomeric band extending from the basket, through the pulley and to the anchor on the basket;
f. a fastener secured to the basket;
g. a release mechanism mounted on the main beam for receiving the fastener when the elastomeric band is stretched, the release mechanism comprising (i) a base plate including a flange, the flange defining, a notch for receiving the fastener; (ii) a firing arm including a body and an elongation, and pivotally secured to the flange at a center of rotation, the firing arm capable of closing over the notch when the fastener is placed in the notch in line with the center of rotation whereby the fastener places no torque on the tiring arm; (iii) a release arm pivotally mounted on the flange between the base plate and the elongation of the firing arm whereby rotation of the release arm pushes on the elongation and rotates the firing arm sufficiently so that the fastener exerts a torque on the firing arm thereby releasing the fastener.
